(19) United States
(12) Patent Application Publication
(10) Pub. No.: US 2026/0246320 A1
(43) Pub. Date: Aug. 20, 2026

(54) STATOR AND ELECTRIC MACHINE

(71) Applicant: Schaeffler Technologies AG & Co. KG, Herzogenaurach (DE)

(72) Inventors: Aurelien Grauss, Mommenheim (FR); Stephan Penner, Bühl (DE); Wolfgang Haas, Bühl (DE)

(21) Appl. No.: 19/161,612

(22) PCT Filed: Feb. 5, 2024
(86) PCT No.: PCT/DE2024/100090

§ 371 Date: Sep. 2, 2025

(30) Foreign Application Priority Data
Mar. 2, 2023 (DE) 10 2023 105 137.7

(51) Int. Cl. H02K 1/20

(52) U.S. Cl. CPC H02K 1/20

(57) ABSTRACT

stator has a cylindrical design with an inner diameter, into which a rotor with an outer diameter can be inserted, thereby forming a cylindrical air gap. The stator includes stator teeth, and a cooling fluid can flow through the stator from a first end face. The first end face is equipped with an attachment body which extends away from the first end face in the axial direction. The stator has a cylindrical fluid guide body with an annular base and an inner casing, which extends outwards axially from the base, and the stator also has an outer casing, which extend outwards axially from the base. The inner casing has an inner diameter which is greater than or equal to the outer diameter of the rotor, and the inner casing and the outer casing of the fluid guide body are fixed to the attachment body.

### CROSS-REFERENCE TO RELATED APPLICATION

The present application is the U.S. National Phase of PCT Patent Application Number PCT/DE 2024/100090, filed on Feb. 5, 2024, which claims priority to German Patent Application Number 10 2023 105 137.7, filed Mar. 2, 2023, the entire disclosures of which are incorporated by reference herein.

### TECHNICAL FIELD

The present disclosure relates to a stator for an electric machine, in particular within a drive train of a motor vehicle, wherein the stator is designed in the form of a cylindrical ring with an inner diameter, in which a rotor with an outer diameter can be inserted, thereby forming a cylindrical air gap, and the stator has a plurality of stator teeth, each stator tooth defining a respective stator slot which is located between adjacent stator teeth in the circumferential direction, extends in the radial direction, runs through the stator in the axial direction, and comprises two slot side walls and a groove base, into which an energizable winding is inserted, said winding comprising a plurality of conductors, wherein a cooling fluid can flow through the stator from the first end face, and an attachment body is arranged on the first end face and extends at least partly away from the first end face in the axial direction. The disclosure further relates to an electric machine.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle which comprises an electric motor that is arranged so as to be concentric and coaxial with respect to a bevel gear differential, a shiftable 2-speed planetary gear set being arranged in the drive train between the electric motor and the bevel gear differential and being likewise positioned to be coaxial with the electric motor and the bevel gear differential or spur gear differential. The drive unit is very compact and allows for a good compromise between gradability, acceleration and energy consumption due to the shiftable 2-speed planetary gear set. Such drive units are also referred to as e-axles or electrically drivable drive trains.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

In the development of electric machines intended for e-axles or hybrid modules, there is a continuing need to increase their power densities, so the cooling of electric machines required for this is growing in importance. Owing to the necessary cooling capacities, hydraulic fluids such as cooling oils have become established in most concepts for the removal of heat from the thermally loaded regions of an electric machine.

Casing cooling as well as winding head cooling are known, for example, from the prior art for cooling electric machines by means of hydraulic fluids. While the casing cooling transfers the heat generated at the outer surface of the stator laminated core into a cooling circuit, the heat transfer takes place in the case of the winding head cooling immediately at the conductors outside the stator laminated core in the region of the winding heads into the fluid.

Further improvements are provided by separate cooling channels, which are introduced both in the stator laminated core (see, for example, EP3157138 A1) and in the slot, in addition to the conductors (see, for example, Markus Schiefer: Indirekte Wicklungskühlung von hochausgenutzten permanenterregten Synchronmaschinen mit Zahnspulenwicklung [Indirect Winding Cooling of Highly Utilized Permanently Excited Synchronous Machines with Toothed Coil Winding], dissertation, Karlsruhe Institute of Technology (KIT), 2017).

Concepts are also known in which hydraulic fluid flows directly around the windings in order to increase the power density. Improved cooling with direct contact of the hydraulic fluid and conductor in the slot is already known per se from the prior art. For example, DE102015013018 A1 describes a solution for electric machines with a single-tooth winding, wherein the fluid flows directly around the windings, which are wound around the teeth.

Electric machines that have a hollow cylindrical stator, i.e., are designed as internal rotor machines, and that are configured for use as a traction drive of a motor vehicle often have a stator winding with a rectangular cross-section in order to achieve a high power density. In electric machines intended for driving motor vehicles, the stator windings are therefore typically designed as windings. In this case, for example, substantially U-shaped wire segments are introduced into the stator slots from one end face of the stator and then shaped at an opposite end face of the stator and connected, for example, by welding.

### SUMMARY

The object of the disclosure is therefore to provide a stator for an electric machine which can provide a high power density and effective cooling. It is also the object of the disclosure to realize a stator that can be manufactured at low cost and is easy to assemble while maintaining a high level of operational reliability. Furthermore, the object of the disclosure is to provide an optimized electric machine.

The object is achieved by a stator for an electric machine, in particular within a drive train of a motor vehicle, wherein the stator is designed in the form of a cylindrical ring with an inner diameter, in which a rotor with an outer diameter can be inserted, thereby forming a cylindrical air gap, and the stator has a plurality of stator teeth, each stator tooth defining a respective stator slot which is located between adjacent stator teeth in the circumferential direction, extends in the radial direction, runs through the stator in the axial direction, and comprises two slot side walls and a groove base, into which an energizable winding is inserted, said winding comprising a plurality of conductors, wherein a cooling fluid can flow through the stator from the first end face, and an attachment body is arranged on the first end face and extends at least partly away from the first end face in the axial direction, wherein the stator has a cylindrical fluid guide body with an annular base and an inner casing which extends outwards axially from the base and an outer casing which extends outwards axially from the base, wherein the inner casing has an inner diameter which is greater than or equal to the outer diameter of the rotor, and where the inner casing and the outer casing of the fluid guide body are fixed to the attachment body by means of an adhesive connection.

This has the advantage that the rotor can be realized in a particularly simple way by axial insertion into the stator, wherein the stator is then already fully assembled and provided with a fluidic cooling system. This means that the fluid guide body can first be connected to the attachment body of the stator using an easy-to-install bonding process, thereby assembling the fluid cooling system of the stator. The rotor can then be inserted axially into the ready-to-operate stator, which simplifies assembly and production logistics.

It is particularly preferable for the fluid guide body to be bonded to the attachment body in an oil-tight manner, so that additional seals such as O-rings can be dispensed with. In order to achieve this, an attachment slot can preferably provide defined adhesive gaps as an adhesive connection, for example in a V-shape. The adhesive is applied as a continuous bead around the entire circumference in the base of an attachment slot. This ensures that adhesive is present over the entire circumference. During assembly of the fluid-guiding element, the adhesive is then pressed into the attachment slot over the entire circumference by means of attachment collars that engage in the attachment slot, thus achieving a closed adhesive ring in an attachment slot so that an oil-tight bond can be achieved. In particular, this can be used to define a dry space inside the stator.

Furthermore, the fluid guide body can preferably be positioned precisely in the circumferential direction relative to the attachment body by suitable centering means, so that, for example, a fluid connection of the fluid guide body can meet a corresponding mating bore.

The winding inserted in the stator slots preferably emerges from the stator, forming a winding head on each of the two end faces of the stator, wherein at least one attachment body is molded into or onto the stator body of the stator. The advantage of this is that a number of different functions can be provided in a component produced by injection molding using an injection-molded attachment body. These functions of the attachment body can, for example, be selected from the group of fixing functions, locking functions, insulation functions and/or sealing functions.

In this context, it is particularly preferred that a plurality of individual laminations or laminated cores of the stator body of the stator are fixed in position relative to one another by means of the attachment body. This in particular eliminates the need for fixation/stabilization/packaging by means of bonding varnish, clinching and/or welding, since this is achieved by the attachment body.

The plastic used to form the attachment body could be a thermoset, such as an epoxy resin, for example, but other plastics are also conceivable in principle. Preferably, the attachment body is formed from a plastic. In principle, it is also conceivable that the attachment body can also be formed from several different plastics, for example by means of a bi-injection molding process.

An attachment body is preferably designed in one piece. However, it is also conceivable that the attachment body is formed in several parts, in which case it is further preferred that the plurality of parts of the attachment body are formed from the same plastic. In principle, it is conceivable for there to be several attachment bodies in or on the stator.

It is highly preferred that the attachment body is molded into or onto the stator body of the stator. This means that the attachment body has been formed in or on the stator body during the injection molding process and not subsequently arranged as a separate component in or on the stator.

According to an advantageous embodiment of the disclosure, it is possible for the stator slots to each have slot side walls extending radially in cross-section and a groove base, wherein the attachment body completely covers the slot side walls and the groove base. The advantage of this embodiment is that the side walls and the groove base are coated with a plastic, eliminating the use of a separate insulating paper. It goes without saying that the plastic has electrically insulating properties for this purpose. It is also preferred in this context that the attachment body has a substantially uniform layer thickness on the slot side walls and the groove base. By completely covering the side walls and the groove base, it is also possible to form a fluid seal between the stator slots and the stator body so that the stator can also have fluid cooling of the stator slots as a result. Furthermore, the attachment body can be formed on the slot side walls and the groove base to support the fixing of the stator laminations or laminated stator cores.

According to a further preferred development of the disclosure, it is also possible for the stator slots to each have a slot opening extending radially in cross-section, with the attachment body closing the slot opening. This makes it possible to close the stator slots radially inwards using the attachment body and, for example, to dispense with the slot-closure wedges that would otherwise be required.

The stator according to the disclosure is preferably designed for use in a radial flux machine. A stator for a radial flux machine usually has a cylindrical structure and generally consists of electrical steel sheets that are electrically insulated from one another and are structured in layers and packed to form laminated cores. Distributed around the circumference, slots are embedded in the electrical steel sheet and arranged to run substantially parallel to the rotor shaft, said slots receiving the stator winding or parts of the stator winding. The stator slots preferably have a substantially U-shaped cross-sectional contour. Most preferably, the stator slots have straight slot walls extending in the radial direction.

A winding with conductors can particularly preferably be embedded in the stator slots of the stator according to the disclosure. A conductor is in particular an electrically conductive conductor with two conductor portions which run in parallel and comprise longitudinal extensions that are significantly larger than their diameters. In principle, the conductor portions can have any cross-sectional shape other than a circular shape. Rectangular cross-sectional shapes are preferred since these allow high packing densities and consequently high power densities to be achieved. Particularly preferably, a conductor is formed of copper. Preferably, a conductor is insulated. To insulate the conductors, for example, mica paper, which for mechanical reasons can be reinforced by a glass fabric carrier, can be wound in tape form around one or more stator windings, which are impregnated by means of a curing resin. In principle, it is also possible to use a curable lacquer layer without mica paper to insulate a conductor.

Most preferably, the winding is designed as a hairpin winding or wave winding. In this context, it is further preferred that the conductors are designed as hairpin conductors.

The stator according to the disclosure also has a stator body. The stator body can be made in one piece or in multiple pieces, in particular in a segmented manner. A one-piece stator body is characterized by the fact that the entire stator body is formed in one piece as viewed over the circumference. The stator body is usually formed from a plurality of stacked laminated electrical steel sheets, with each of the electrical steel sheets being closed to form a circular ring. A segmented stator body is characterized by the fact that it is constructed from individual stator segment parts. The stator body can be constructed from individual stator teeth or stator tooth groups, and each individual stator tooth or each individual stator tooth group can be formed from a plurality of stacked laminated electrical steel sheets, with each of the electrical sheets being designed as a stator segment lamination part.

The stator body is preferably formed from one or more stator laminated cores. A stator laminated core is understood to mean a plurality of laminated individual laminations or stator sheets, which are generally made from electrical steel sheets and are layered and packed one on top of the other to form a stack or what is referred to as a stator laminated core. The individual laminations can then remain held together in the laminated core by adhesive bonding, welding or screwing.

The stator teeth of the stator are preferably formed in the stator body. Stator teeth are components of the stator body which are designed as circumferentially spaced, tooth-like parts of the stator body that are directed radially inward, with an air gap for the magnetic field being formed between the free ends of the stator teeth and a rotor body. The gap between the rotor and the stator is referred to as the air gap. In a radial flux machine, this is a substantially annular gap with a radial width that corresponds to the distance between the rotor body and the stator body.

In particular, the stator can be provided for use in an electric machine within a drive train of a motor vehicle. The electric machine is intended in particular for use within a drive train of a hybrid or fully electrically driven motor vehicle. In particular, the electric machine is dimensioned such that vehicle speeds of more than 50 km/h, preferably more than 80 km/h, and in particular more than 100 km/h can be achieved. The electric machine particularly preferably has an output of more than 30 KW, preferably more than 50 kW and in particular more than 70 kW. Furthermore, it is preferred that the electric machine provides rotational speeds greater than 5,000 rpm, particularly preferably greater than 10,000 rpm, very particularly preferably greater than 12,500 rpm.

According to an advantageous embodiment of the disclosure, the plurality, preferably all, of the electrical conductors have a substantially rectangular contour in cross-section. The advantage of this design is that electrical conductors that are generally available as standard can be used to form the stator winding, which is particularly favorable in terms of the manufacturing costs of the stator.

The function of the cooling fluid in the stator according to the disclosure is to dissipate heat as efficiently as possible from regions of the stator that are heating up and to prevent these regions from overheating. In addition to this main task, the cooling fluid can in particular also provide lubrication and corrosion protection for the moving parts and/or the metal surfaces of the cooling system of the stator or the electric machine. In addition, it can, in particular, also remove contaminants (for example as caused by abrasion), water and air. The cooling fluid is preferably a liquid. The cooling fluid can in particular be an oil. In principle, however, it is also conceivable to use aqueous cooling fluids, for example also emulsions, such as water-glycol mixtures.

The cooling fluid of the stator can be connected to a hydraulic cooling system with a hydraulic cooling circuit. Such a hydraulic cooling system is used to dissipate the heat generated by electrical losses within an electric machine. Such a cooling system can have cooling channels within the rotor (rotor cooling channel) and/or stator (stator cooling channel), in particular also a flow through the stator slots, through which a corresponding cooling fluid is guided for the purpose of removing the heat.

The cooling fluid can particularly preferably be pumped through the hydraulic circuit by means of a pump. In principle, it is conceivable to design a plurality of hydraulic circuits in order to cool the electric machine. In this case, it is highly preferred that the cooling channels of the stator are connected to a hydraulic cooling circuit or to various cooling circuits of the cooling system. In particular, by connecting to several cooling circuits, it is possible to provide more precise cooling, since, for example, the temperature of the cooling fluid when entering the cooling channels of the stator, the flow velocity of the cooling fluid or even the type of cooling fluid (oil, emulsion) can be adjusted.

The stator slots are preferably closed by a slot-closure means so that the cooling fluid cannot flow from the stator slots into the air gap between the rotor and the stator. Particularly preferably, the slot-closure means is a slot-closure wedge.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

Further advantageous embodiments of the disclosure are specified in the dependent claims. The features listed individually in the dependent claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, it can be provided that the inner diameter of the cylindrical fluid guide body is greater than or equal to the inner diameter of the stator. The advantage of this design is that a particularly large joint clearance can be provided for inserting the rotor, which also reduces the risk of damage to the fluid guide body during rotor assembly.

According to a further preferred further development of the disclosure, it can also be provided that the fluid guide body has a fluid connection on its outer casing which extends out of the outer casing in the radial direction. This allows the fluid guide body to be connected to a cooling circuit, for example, in a way that is particularly easy to install and accessible.

Furthermore, according to an equally advantageous embodiment of the disclosure, it can be provided that the attachment body has a cylindrical inner connection section on the inner diameter of the stator, which extends axially from the stator and to which the inner casing of the fluid guide body is fixed by means of the adhesive connection and/or the attachment body has a cylindrical outer connection section which extends outwards axially from the stator, to which the outer casing of the fluid guide body is fixed by means of the adhesive connection.

The advantageous effect of this design is based on the fact that a defined, in particular also circumferentially closed adhesive connection can be provided.

According to a further particularly preferred embodiment of the disclosure, it may be provided that the outer connection section has a first attachment slot in which a first attachment collar of the outer casing engages or the outer casing has a first attachment slot in which a first attachment collar of the outer connection section engages, wherein the adhesive connection is formed between the first attachment slot and the first attachment collar. This has the particular effect that the quality of the adhesive connection can be further improved by the attachment slots. The first attachment slot can preferably have a closed circumferential design. Accordingly, it is also preferred that the first attachment collar is closed all the way around. It may also be preferable for the first attachment slot and the first attachment collar to be ring-segmented or annular.

Furthermore, the disclosure can also be further developed in such a way that the inner connection section has a circumferential second attachment slot into which a circumferential second attachment collar of the inner casing engages or the inner casing has a circumferential second attachment slot, into which a circumferential second attachment collar of the inner connection section engages, wherein the adhesive connection is formed between the second attachment slot and the second attachment collar. Here too, the attachment slot can help to improve the adhesive connection. The second attachment slot can preferably have a closed circumferential design. Accordingly, it is also preferred that the second attachment collar is closed all the way around. It may also be preferable for the second attachment slot and the second attachment collar to be ring-segmented or annular in shape.

According to a further, preferred embodiment of the disclosure, it may be provided that the first attachment slot has a V-shaped contour in the axial section, into which the first attachment collar engages with a correspondingly shaped V-shaped contour and/or the second attachment slot has a V-shaped contour in the axial section, into which the second attachment collar engages with a correspondingly shaped V-shaped contour. This enables precise adjustment of the bonding gap through axial displacement and thus a certain tolerance compensation.

In an equally preferred embodiment of the disclosure, it may also be provided that first spacer ribs are formed on the first attachment collar and/or the first attachment slot, by means of which a first minimum adhesive gap between the attachment collar and the first attachment slot can be defined and/or second spacer ribs are formed on the second attachment collar and/or the second attachment slot, by means of which a second minimum adhesive gap between the attachment collar and the first attachment slot can be defined. This ensures that the adhesive connection can provide a defined layer thickness and therefore also load-bearing capacity.

It can also be advantageous to further develop the disclosure in such a way that a first centering means is formed on the outer casing, which engages in a corresponding second centering means of the attachment body in such a way that the fluid guide body is fixed relative to the attachment body in the circumferential direction and/or in the radial direction. The advantage of this is that the fluid guide body can be prevented from twisting relative to the attachment body during assembly before the two parts form the bond. This prevents twisting of components that are already in contact with the adhesive.

According to a further preferred embodiment of the object of the disclosure, it can be provided that the centering means are arranged asymmetrically around the circumference. This means that the two components can only be positioned axially in their end positions in relation to each other in a predefined circumferential position.

The object of the disclosure is further achieved by an electric machine, in particular for a drive train of a motor vehicle, wherein the stator is designed to be cylindrical with an inner diameter, in which a rotor with an outer diameter is rotatably mounted, thereby forming a cylindrical air gap.

### BRIEF DESCRIPTION OF THE DRAWINGS

The disclosure is explained in more detail below with reference to figures without limiting the general concept of the disclosure.

### In the Figures:

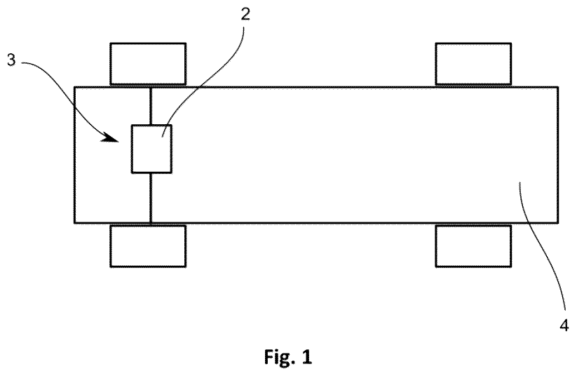

FIG. 1 shows a motor vehicle comprising an electric axle drive train in a schematic representation,

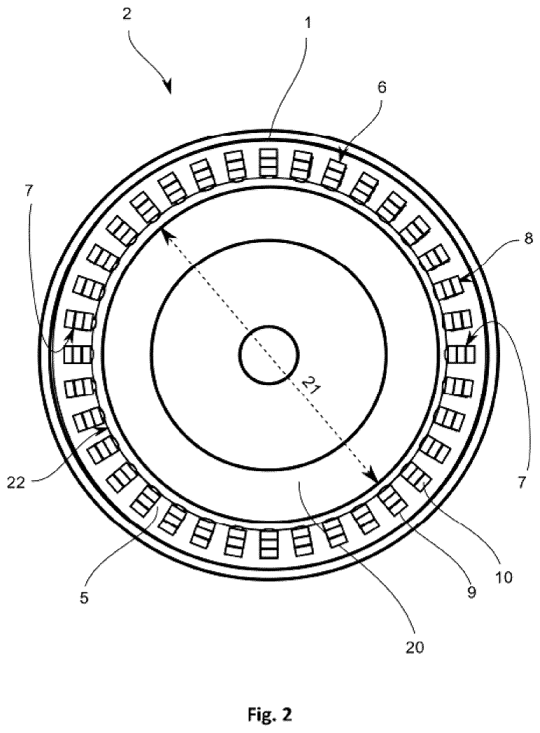

FIG. 2 shows an electric machine in a cross-sectional view,

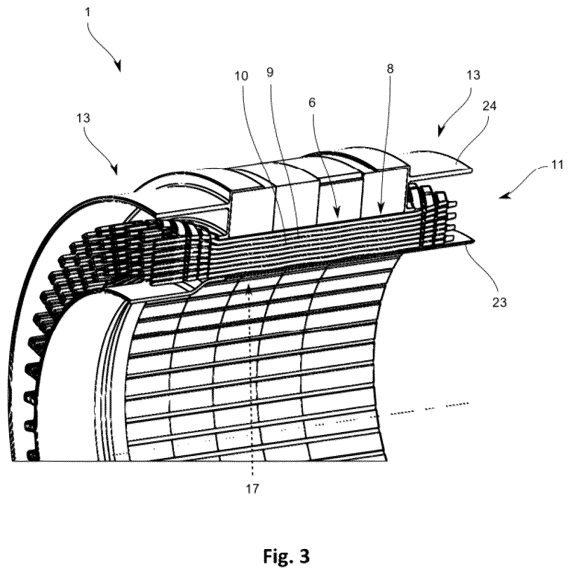

FIG. 3 shows a stator in a perspective axial sectional view,

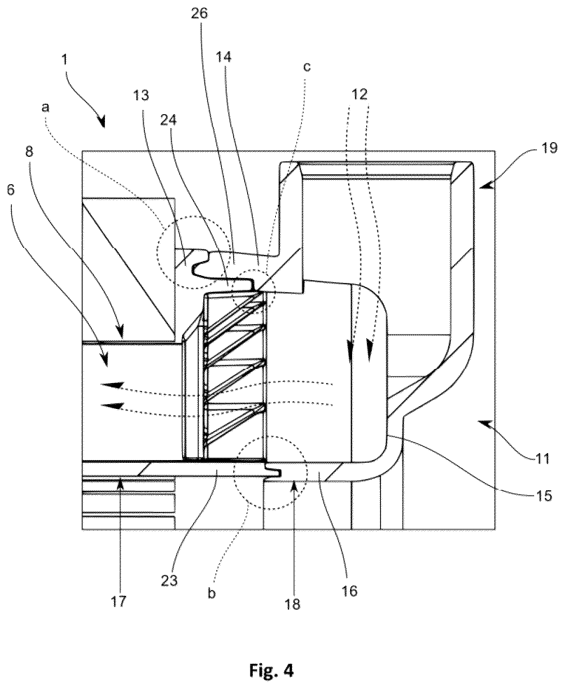

FIG. 4 shows a first detailed view of an electric machine with a bonded fluid guide body in an axial sectional view,

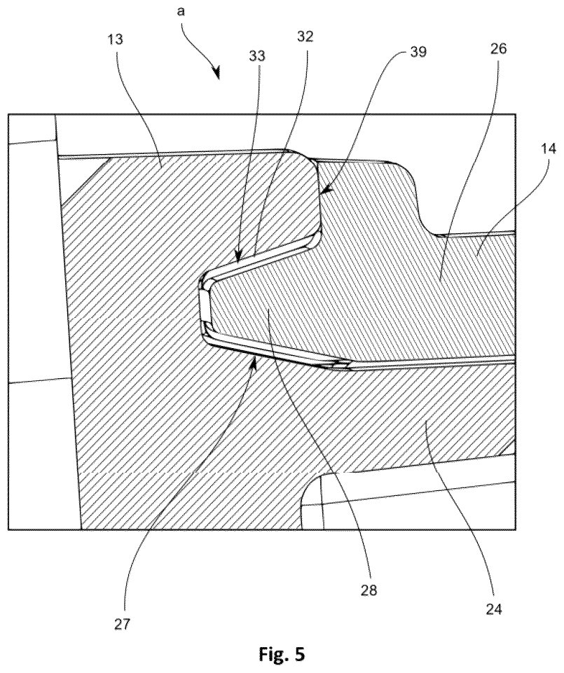

FIG. 5 shows a detailed view of the outer casing of the fluid guide body in an axial sectional view,

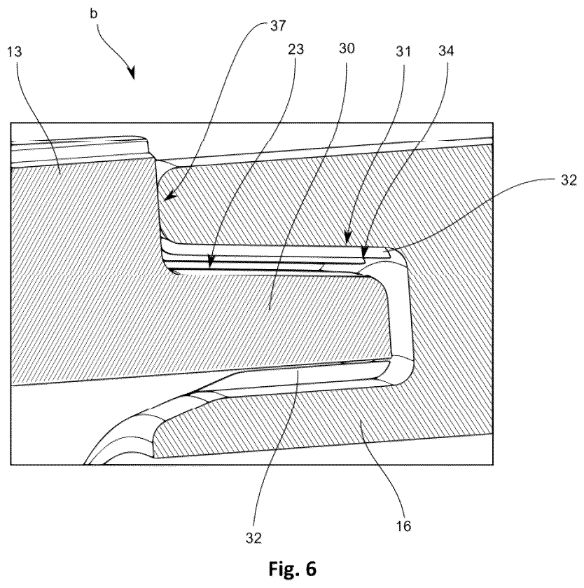

FIG. 6 shows a detailed view of a first embodiment of an inner casing of the fluid guide body in an axial sectional view,

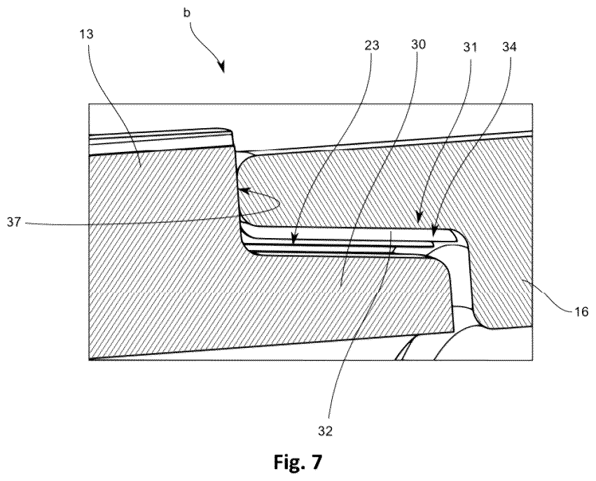

FIG. 7 shows a detailed view of a second embodiment of an inner casing of the fluid guide body in an axial sectional view,

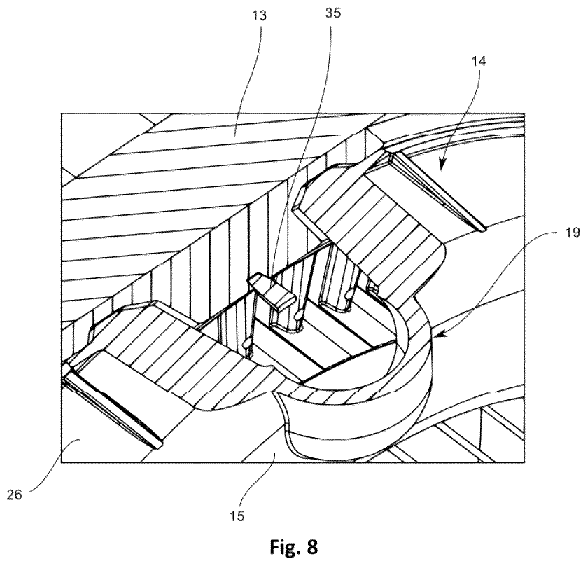

FIG. 8 shows a detailed view of the fluid connection of the fluid guide body in a partial sectional view,

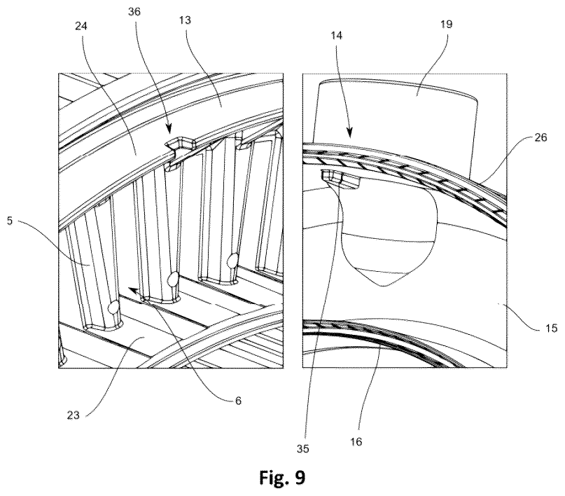

FIG. 9 shows a first detailed view of the attachment body with a centering means and a second detailed view of the fluid guide body with a centering means,

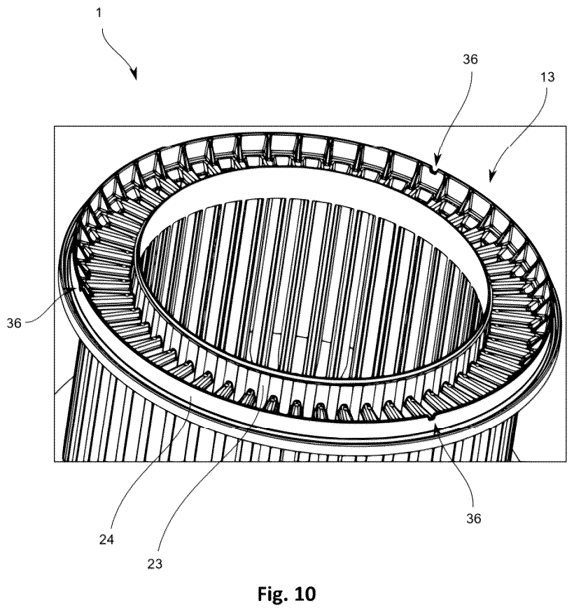

FIG. 10 shows a perspective view of the stator body with an attachment body,

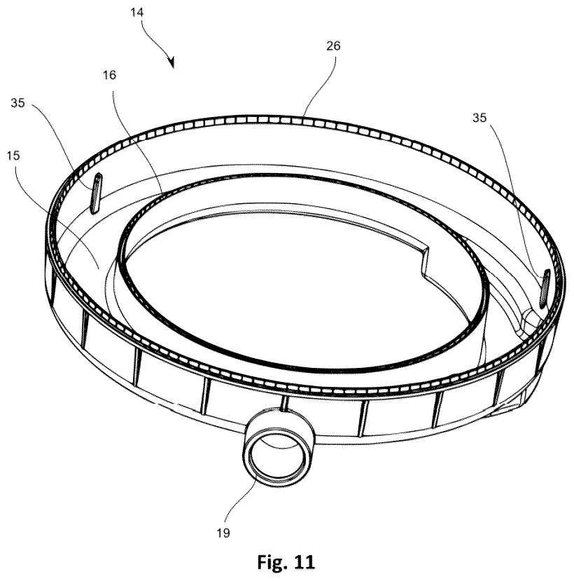

FIG. 11 shows a perspective view of the fluid guide body.

### DETAILED DESCRIPTION

FIGS. 1 and 2 shows a stator 1 for an electric machine 2, in particular within a drive train 3 of a motor vehicle 4, as can also be seen by way of example in FIG. 1. The stator 1 is designed to be cylindrical with an inner diameter 17, in which a rotor 20 with an outer diameter 21 can be inserted, thereby forming a cylindrical air gap 22. Furthermore, the stator 1 has a plurality of stator teeth 5, which in the circumferential direction between adjacent stator teeth 5 each define a stator slot 6 that extends in the radial direction, runs in the axial direction through the stator 1 and has two slot side walls 7 and a groove base 8, into which an energizable winding 9 comprising a plurality of conductors 10 is inserted. In the configuration shown, the electric machine 2 is configured as an internal rotor.

As shown in FIG. 3, the stator 1 has an attachment body 13 on the first end face 11 that extends at least partly away from the first end face 11 in the axial direction. This attachment body 13 in turn has a first cylindrical connection section 23 which extends from the stator body of the stator 1 in the axial direction, which runs radially below a winding head of the winding 9. In the embodiment shown, the attachment body 13 also has a second cylindrical connection section 24 which extends outwards axially from the stator body of the stator 1, which runs radially above the winding head of the winding 9. As a result, the winding head is enclosed by an annular space defined by the inner cylindrical connection section 23 and the outer cylindrical connection section 24. It is possible that the connection sections 23, 24 are formed in two pieces and have no physical connection to each other, but were molded onto the stator body of the stator 1 in the same injection molding process. Here, the connection sections 23, 24 are molded from the same plastic. FIG. 3 shows an embodiment in which an attachment body 13 is also formed on the end face of the stator 1 opposite the end face 11.

In the embodiment shown in FIG. 3, the attachment body 13, which is formed from a plastic, is injection-molded onto the end face 11 of the stator 1, for example using a corresponding injection molding process. The stator slots 6 with their slot side walls 7 and the respective groove base 8 are also at least partly injection-molded with a plastic coating, which is formed monolithically with the attachment body 13.

As can be seen in particular from FIG. 4, a cooling fluid 12 can flow through the stator 1 from at least a first end face 11. To supply the cooling fluid 12, the stator 1 has a cylindrical fluid guide body 14 with an annular base 15 and an inner shell 16 extending axially out of the base 15 and an outer shell 26 which extends outwards axially from the base 15. In this configuration, the fluid guide body 14 is reminiscent of a donut baking mold. The inner casing 16 has an inner diameter 18 that is greater than or equal to the outer diameter 21 of the rotor 20, so that the rotor 20 can be pushed axially into the stator 1 from the end face 11. For this purpose, the inner diameter 18 of the cylindrical fluid guide body 14 can also be larger than or equal to the inner diameter 17 of the stator 1, which also enables axial insertion of the rotor 20 during assembly of the electric machine 2. The attachment body 13 is molded onto and attached to the laminated core of the stator body of stator 1. The fluid guide body 14 is therefore bonded to this attachment body 13 at two coaxially extending cylindrical connection sections 23, 24. The adhesive bonds between the attachment body 13 and the fluid guide body 14 are oil-tight, so that there is no need for O-rings, for example. The attachment body 13 and the fluid guide body 14 have centering means 35, 36 in order to position the two rotationally correctly in relation to each other, which will be explained in more detail later.

Furthermore, the fluid guide body 14 has a fluid connection 19 on its outer casing 26 extending radially out of the outer casing 26, via which the cooling fluid 12 can be guided through the fluid guide body 14 and via the attachment body 13 into the stator slots 6, where it can cool the winding 9 of the stator 1 accordingly. This is also known as direct slot cooling.

The inner casing 16 and the outer casing 26 of the fluid guide body 14 are fixed to the attachment body 13 by means of an adhesive bond. For this purpose, the attachment body 13 has a cylindrical inner connection section 23 on the inner diameter 17 of the stator 1, which extends axially from the stator 1 and to which the inner casing 16 of the fluid guide body 14 is fixed by means of the adhesive bond. Furthermore, the attachment body 13 has a cylindrical outer connection section 24 which extends outwards axially from the stator 1, to which the outer casing 26 of the fluid guide body 14 is also fixed by means of the adhesive bond.

FIG. 5 shows that the outer connection section 24 has a circumferential first attachment slot 27, in which a circumferential first attachment collar 28 of the outer casing 26 engages, wherein the adhesive connection is formed between the first attachment slot 27 and the first attachment collar 28. First spacer ribs 32 are formed on the first attachment collar 28 and/or the first attachment slot 27, by means of which a first minimum adhesive gap 33 between the attachment collar 28 and the first attachment slot 27 can be defined. FIG. 5 thus shows the outer bond, which has a similar V-shaped attachment slot 27 as the inner bond, which will be explained below. The fluid guide body 14 and the attachment body 13 have an annular stop 39 that extends radially above the minimum adhesive gap 33, by means of which the axial position of the two components in relation to each other is defined.

A precise adjustment of the bonding gap and thus a certain tolerance compensation through axial positioning of the fluid guide body 14 in relation to the attachment body 13 can also be achieved in that the first attachment slot 27 has a V-shaped contour in the axial section, into which the first attachment collar 28 engages with a correspondingly shaped V-shaped contour. The same applies to the second attachment slot 31, which also has a V-shaped contour in the axial section, into which the second attachment collar 30 engages with a correspondingly shaped V-shaped contour. As shown in FIGS. 5-6, this results in V-shaped adhesive slots with a first axially extending slot section, which is followed by a radially extending slot section, followed by a second axially extending slot section.

FIGS. 6-7 show two embodiments of inner connection sections 23, wherein in the inner connection section 23 the inner casing 16 in each case has a circumferential second attachment slot 31, into which a circumferential second attachment collar 30 of the inner connection section 23 engages, wherein the adhesive connection is then formed between the second attachment slot 31 and the second attachment collar 30. Second spacer ribs 32 are also formed on the second attachment collar 30 and/or the second attachment slot 31, by means of which a second minimum adhesive gap 34 between the attachment collar 30 and the first attachment slot 31 can be defined.

FIG. 6 shows a detailed view of a first embodiment of the internal bonding. Here, end faces on the attachment body 13 and on the fluid guide body 14 serve as axial stops 37, 39. The spacer ribs 32 were provided on the fluid guide body 14 so that a precisely defined minimum adhesive gap 34 is formed, which is necessary for the bond to have the designed strength. The bonding gap extending in the axial direction is uninterrupted in both the circumferential and axial directions and is not impaired by spacer ribs 32. This ensures that the bond is sealed. The spacer ribs 32 on the bonding gaps extending in the axial direction ensure in particular the necessary strength of the bond, while the radially extending bonding gap primarily ensures sealing. Because the spacer ribs 32 of the fluid guide body 14 can come into contact with the surface of the attachment body 13, it is not always possible to guarantee the impermeability of these axially extending adhesive gaps.

In this embodiment of FIG. 6, the inner diameter of the fluid guide body 14 is also larger than the outer diameter 21 of the rotor 20 in order to ensure its assembly by axial insertion into the stator 1. The air gap 22 between rotor 20 and stator 1 not only serves as a joining clearance during assembly, but also compensates for the deformation of the rotor 20 resulting from the centrifugal force and other tolerances. However, since the rotor 20 does not lie within the fluid guide body 14 and rotates during operation of the electric machine 2, only the joint clearance is required for assembly. The inner diameter 18 of the fluid guide body 14 can therefore also be smaller than the inner diameter 17 of the stator 1. This configuration is shown in FIG. 4 and FIG. 6.

Depending on the design of the electric machine 2, the clearance between the rotor 20 and the stator 1 can be larger or smaller. In the case of closely mounted rotors 20, however, the fluid guide body 14 must have an inner diameter 18 that is not significantly smaller than the inner diameter 17 of the stator 1. This is achieved by the design of the inner bond shown in FIG. 7. The lower side of the V-shaped attachment slot 31 of the fluid guide body 14 has been removed from the embodiment known from FIG. 6, wherein the adhesive principle remains unchanged. However, the adhesive no longer remains enclosed in the V-shaped attachment slot 31, which may make the bonding process more difficult during manufacture. However, this solution also works with very narrow air gaps between rotor 20 and stator 1. Due to its geometry, the V-shaped attachment slot 31 in FIG. 6 has the advantage that the adhesive material is better pressed or subjected to pressure. This pressure is a prerequisite for creating an optimum bond.

FIGS. 8-9 show that a first centering means 35 is formed on the outer casing 26, which engages in a corresponding second centering means 36 of the attachment body 13 in such a way that the fluid guide body 14 is fixed relative to the attachment body 13 in the circumferential direction and/or in the radial direction.

When mounting the fluid guide body 14, it must first engage in a corresponding slot-like centering means 36 in the attachment body 13 via a radially inwardly projecting centering means 35 so that the bonds can also meet their attachment slots 27, 31 in a second step. This sequence is necessary to ensure an optimum bond. If the two contact surfaces of the two bonds are already in contact before rotational positioning, then these surfaces would have to slide towards each other during assembly due to the rotation of the fluid guide body 14, which could impair the adhesive layer.

The adhesive connection is oil-tight in the exemplary embodiments shown. To ensure this, the adhesive layer must not be damaged during assembly of the fluid guide body 14. If the centering means 35 of the fluid guide body 14 does not immediately meet its corresponding centering means 36 on the attachment body 13, the fluid guide body 14 could easily tip over due to the axial joining force applied and the other side of the section of the fluid guide body 14 to be bonded could already meet the corresponding attachment slot on the attachment body 13. This could then “interrupt” the adhesive layer and thus cause leaks. It is therefore preferable to arrange several pairs of corresponding centering means 35, 36 distributed around the circumference of the stator 1. In FIGS. 10-11, there are three centering means 35, 36 arranged asymmetrically around the circumference, so that the fluid guide body 14 can only be mounted in a defined circumferential position relative to the attachment body 13, which corresponds to a poka-yoke solution.

As long as the pairwise corresponding centering means 35, 36 are not arranged in their defined circumferential joining position relative to one another, the section of the fluid guide body 14 to be bonded does not come into contact with the V-shaped attachment slots 27, 31 of the attachment body 13. Thus the adhesive layer remains uninterrupted. FIG. 10 shows a possible arrangement of the groove-like centering means 36 on the attachment body 13, where the grooves are rotated by 105, 120 and 135° relative to one another. The solution with only one groove-like centering means 36 is also conceivable, wherein assembly using an auxiliary device is preferable in order to avoid tilting and thus contact between the sealing surfaces in the two V-slots before rotary positioning.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features of the same type without defining an order of precedence.

### LIST OF REFERENCE SYMBOLS

1 Stator
2 Electric machine
3 Drive train
4 Motor vehicle
5 Stator teeth
6 Stator slot
7 Slot side walls
8 Groove base
9 Winding
10 Conductor
11 End face
12 Cooling fluid
13 Attachment body
14 Fluid guide body
15 Base
16 Inner casing
17 Inner diameter
18 Inner diameter
19 Fluid connection
20 Rotor
21 Outer diameter
22 Air gap
23 Connection section
24 Connection section
26 Outer casing
27 Attachment slot
28 Attachment collar
30 Attachment collar
31 Attachment slot
32 Spacer ribs
33 Minimum adhesive gap
34 Minimum adhesive gap
35 Centering means
36 Centering means
37 Stop
39 Stop

1. A stator for an electric machine comprising:
a cylindrical ring with an inner diameter, in which a rotor with an outer diameter is inserted to form a cylindrical air gap; and
a plurality of stator teeth, each stator tooth defining a respective stator slot located between adjacent stator teeth in the circumferential direction, extending in the radial direction, running through the stator in the axial direction, and comprising two slot side walls and a groove base, into which an energizable winding is inserted, the winding comprising a plurality of conductors, a cooling fluid flowable through the stator from at least a first end face, and an attachment body being arranged on the first end face and extending at least partly away from the first end face in the axial direction;
a cylindrical fluid guide body with an annular base and an inner casing extending outwards axially from the base and an outer casing extending outwards axially from the base, wherein the inner casing has an inner diameter which is greater than or equal to the outer diameter of the rotor, and wherein the inner casing and the outer casing of the fluid guide body are fixed to the attachment body by means of an adhesive connection.

2. The stator according to claim 1, wherein the inner diameter of the cylindrical fluid guide body is greater than or equal to the inner diameter of the stator.

3. The stator according to claim 1, wherein the fluid guide body has a fluid connection on its outer casing extending in the radial direction out of the outer casing.

4. The stator according to claim 1, wherein the attachment body has a cylindrical inner connection section on the inner diameter of the stator which extends axially from the stator and to which the inner casing of the cylindrical fluid guide body is fixed by means of the adhesive connection and/or the attachment body has a cylindrical outer connection section which extends outwards axially from the stator, to which the outer casing of the cylindrical fluid guide body is fixed by means of the adhesive connection.

5. The stator according to claim 4, wherein the outer connection section has a first attachment slot in which a first attachment collar of the outer casing engages or the outer casing has a first attachment slot in which a first attachment collar of the outer connection section engages, wherein the adhesive connection is formed between the first attachment slot and the first attachment collar.

6. The stator according to claim 5, wherein the inner connection section has a second attachment slot in which a second attachment collar of the inner casing engages or the inner casing has a second attachment slot in which a second attachment collar of the inner connection section engages, wherein the adhesive connection is formed between the second attachment slot and the second attachment collar.

7. The stator according to claim 5, wherein the first attachment slot has a V-shaped contour in the axial section, into which the first attachment collar engages with a correspondingly shaped V-shaped contour and/or the second attachment slot has a V-shaped contour in the axial section, into which the second attachment collar engages with a correspondingly shaped V-shaped contour.

8. The stator according to one of claims 5, wherein first spacer ribs are formed on the first attachment collar and/or the first attachment slot, by means of which a first minimum adhesive gap between the attachment collar and the first attachment slot can be defined and/or second spacer ribs are formed on the second attachment collar and/or the second attachment slot, by means of which a second minimum adhesive gap between the attachment collar and the first attachment slot can be defined.

9. The stator according to claim 1, wherein a first centering means is formed on the outer casing, which engages in a corresponding second centering means of the attachment body in such a way that the fluid guide body is fixed relative to the attachment body in the circumferential direction and/or in the radial direction.

10. The stator according to claim 9, wherein the centering means are arranged asymmetrically around the circumference.

11. An electric machine, for a drive train of a motor vehicle, wherein the stator is cylindrical with an inner diameter, in which a rotor with an outer diameter is rotatably mounted, thereby forming a cylindrical air gap, wherein the stator is designed according to claim 1.

12. A stator for an electric machine comprising:
a cylindrical ring with an inner diameter, a rotor with an outer diameter is inserted into the cylindrical ring to form a cylindrical air gap;
a plurality of stator teeth, each stator tooth defining a respective stator slot located between adjacent stator teeth in the circumferential direction, extending in the radial direction, running through the stator in the axial direction, and comprising two slot side walls and a groove base,
an energizable winding inserted into the stator slots, the winding comprising a plurality of conductors, a cooling fluid flowable through the stator from at least a first end face, and an attachment body arranged on the first end face and extending at least partly away from the first end face in the axial direction; and
a cylindrical fluid guide body with an annular base and an inner casing extending outwards axially from the base and an outer casing extending outwards axially from the base, wherein the inner casing has an inner diameter greater than or equal to the outer diameter of the rotor, and wherein the inner casing and the outer casing of the fluid guide body are fixed to the attachment body,
the attachment body including a cylindrical inner connection section on the inner diameter of the stator extending axially from the stator and to which the inner casing of the cylindrical fluid guide body is fixed,
the attachment body including a cylindrical outer connection section extending outwards axially from the stator and to which the outer casing of the cylindrical fluid guide body is fixed.

13. The stator according to claim 12, wherein the inner diameter of the cylindrical fluid guide body is greater than or equal to the inner diameter of the stator.

14. The stator according to claims 12, wherein the fluid guide body has a fluid connection on its outer casing extending in the radial direction out of the outer casing.

15. The stator according to claim 12, wherein the outer connection section has a first attachment slot in which a first attachment collar of the outer casing engages or the outer casing has a first attachment slot in which a first attachment collar of the outer connection section engages.

16. The stator according to claims 15, wherein the inner connection section has a second attachment slot in which a second attachment collar of the inner casing engages or the inner casing has a second attachment slot in which a second attachment collar of the inner connection section engages.

17. The stator according to claims 15, wherein the first attachment slot has a V-shaped contour in the axial section, into which the first attachment collar engages with a correspondingly shaped V-shaped contour and/or the second attachment slot has a V-shaped contour in the axial section, into which the second attachment collar engages with a correspondingly shaped V-shaped contour.

18. The stator according to one of claims 15, further comprising: first spacer ribs formed on the first attachment collar and/or the first attachment slot.

19. The stator according to one of claims 18, further comprising:
second spacer ribs formed on the second attachment collar and/or the second attachment slot.

20. A drive train comprising:
an electric machine, the electric machine including a stator and a rotor, wherein the stator comprises:
a cylindrical ring with an inner diameter, the rotor with an outer diameter is inserted into the cylindrical ring to form a cylindrical air gap;
a plurality of stator teeth, each stator tooth defining a respective stator slot located between adjacent stator teeth in the circumferential direction, extending in the radial direction, running through the stator in the axial direction, and comprising two slot side walls and a groove base,
an energizable winding inserted into the stator slots, the winding comprising a plurality of conductors, a cooling fluid flowable through the stator from at least a first end face, and an attachment body arranged on the first end face and extending at least partly away from the first end face in the axial direction; and
a cylindrical fluid guide body with an annular base and an inner casing extending outwards axially from the base and an outer casing extending outwards axially from the base, wherein the inner casing has an inner diameter greater than or equal to the outer diameter of the rotor, and wherein the inner casing and the outer casing of the fluid guide body are fixed to the attachment body.
